(19) United States
(12) Patent Application Publication
(10) Pub. No.: US 2013/0337360 A1
(43) Pub. Date: Dec. 19, 2013

(54) FUEL CELL COMPONENTS HAVING POROUS ELECTRODES

(71) Applicants: F. Michael Mahoney, Holliston, MA (US); John D. Pietras, Sutton, MA (US)

(72) Inventors: F. Michael Mahoney, Holliston, MA (US); John D. Pietras, Sutton, MA (US)

(21) Appl. No.: 13/975,932

(22) Filed: Aug. 26, 2013

Related U.S. Application Data
(63) Continuation of application No. 11/621,447, filed on Jan. 9, 2007.
(60) Provisional application No. 60/757,686, filed on Jan. 9, 2006.

(51) Int. Cl. H01M 4/86

(52) U.S. Cl. CPC H01M 4/861
USPC 429/465; 429/495; 429/496; 429/482

(57) ABSTRACT

An SOFC component includes a first electrode, an electrolyte overlying the first electrode, and a second electrode overlying the electrolyte. The second electrode includes a bulk layer portion and a functional layer portion, the functional layer portion being an interfacial layer extending between the electrolyte and the bulk layer portion of the second electrode, wherein the bulk layer portion has a bimodal pore size distribution.

### CROSS-REFERENCE TO RELATED APPLICATION(S)

The present application is a continuation application of U.S. patent application Ser. No. 11/621,447, filed Jan. 9, 2007 entitled “FUEL CELL COMPONENTS HAVING POROUS ELECTRODES,” naming inventors F. Michael Mahoney and John D. Pietras, which claims priority from U.S. Provisional Patent Application No. 60/757,686, filed Jan. 9, 2006,entitled “FUEL CELL COMPONENTS HAVING POROUS ELECTRODES,” naming inventors F. Michael Mahoney and John D. Pietras, which application is incorporated by reference herein in its entirety.

### BACKGROUND

1. Field of the Disclosure

The present invention generally relates to solid oxide fuel cells (SOFCs).

2. Description of the Related Art

In pursuit of high-efficiency, environmentally friendly energy production, solid oxide fuel cell (SOFC) technologies have emerged as a potential alternative to conventional turbine and combustion engines. SOFCs are generally defined as a type of fuel cell in which the electrolyte is a solid metal oxide (generally non-porous or limited to closed porosity), in which O²⁻ ions are transported from the cathode to the anode. Fuel cell technologies, and particularly SOFCs, typically have a higher efficiency and have lower CO and NOx emissions than traditional combustion engines. In addition, fuel cell technologies tend to be quiet and vibration-fee. Solid oxide fuel cells have an advantage over other fuel cell varieties. For example, SOFCs may use fuel sources such as natural gas, propane, methanol, kerosene, and diesel, among others because SOFCs operate at high enough operating temperatures to allow for internal fuel reformation. However, challenges exist in reducing the cost of SOFC systems to be competitive with combustion engines and other fuel cell technologies. These challenges include lowering the cost of materials, improving degradation or life cycle, and improving operation characteristics such as current and power density.

Among the many challenges with the manufacture of SOFCs, the formation of porous electrodes, particularly, cathode and anode layers that have an interconnected network of pores for delivery of fuel and air to the electrolyte interface, remains a notable engineering hurdle. In this respect, prior art techniques have focused on processes such as use of a subtractive, fugitive component that is generally volatilized during heat treatment, leaving behind an interconnected network of pores. Use of fugitive pore formers generally results in a large volume of gas generated during heat treatment, which tends to create cracks in the SOFC cell. Other techniques have focused on a very thin functional layer portion of the electrodes extending along and contacting the electrolyte, while relying upon a manifold structure for delivery of air and fuel to the SOFC cell. However, internal manifolds are difficult to produce in a commercially viable manner. In light of the foregoing, the industry continues to demand SOFC cells and SOFC cell stacks that may be produced in a reproducible, cost-effective manner.

### SUMMARY

According to one embodiment, an SOFC component is provided that includes a first electrode layer, an electrolyte layer overlying the first electrode layer, and a second electrode layer overlying the electrolyte layer. The second electrode layer includes at least two regions, a bulk layer portion and a functional layer portion, the functional layer portion being an interfacial layer extending between the electrolyte layer and the bulk layer portion of the second electrode layer. The bulk layer portion has a bimodal pore size distribution.

According to another embodiment, an SOFC component is provided that includes a first electrode layer, an electrolyte layer overlying the first electrode layer, and a second electrode layer overlying the electrolyte layer. The second electrode layer has a bimodal grain size distribution.

According to another embodiment, a method for forming an SOFC component is provided that includes forming a first electrode layer, an electrolyte layer and a second electrode layer. The second electrode layer comprises a powder composed of agglomerates. Further, the layers are heat treated to form the SOFC component.

According to yet another embodiment, a method of forming an SOFC component is provided that includes forming green first layers: electrode, electrolyte, and second electrode layers, the second electrode layer having a green density ρ_{g}. Further, processing continues with sintering of the layers to densify the layers, the green second electrode layer forming a densified second electrode layer, the densified second electrode layer having a sintered density ρₛ and having porosity, the porosity of the densified second electrode layer being achieved without fugitive pore formers.

### BRIEF DESCRIPTION OF THE DRAWINGS

FIG. 1 shows a process flow according to an embodiment of the present invention.

FIG. 2 illustrates as-received LSM powder that may be utilized for formation of a cathode layer according to embodiments of the present invention.

FIG. 3 illustrates the powder of FIG. 2 after heat treatment to form agglomerated powder.

FIG. 4 is an SEM cross-section showing various layers of a fuel cell according to an embodiment of the present invention.

FIGS. 5 & 6 show SEM cross-sections of cathode and anode bulk layers, respectively.

FIG. 7 illustrates pore size distribution according to an embodiment.

FIG. 8 shows a portion of an SOFC cell according to an embodiment of the present invention.

FIG. 9 is a cross-sectional view of an SOFC cell according to an embodiment.

FIG. 10 is an exploded cross-sectional view of the SOFC cell shown in FIG. 9.

FIG. 11 illustrates a state of the art SOFC cell.

### DESCRIPTION OF THE PREFERRED EMBODIMENT(S)

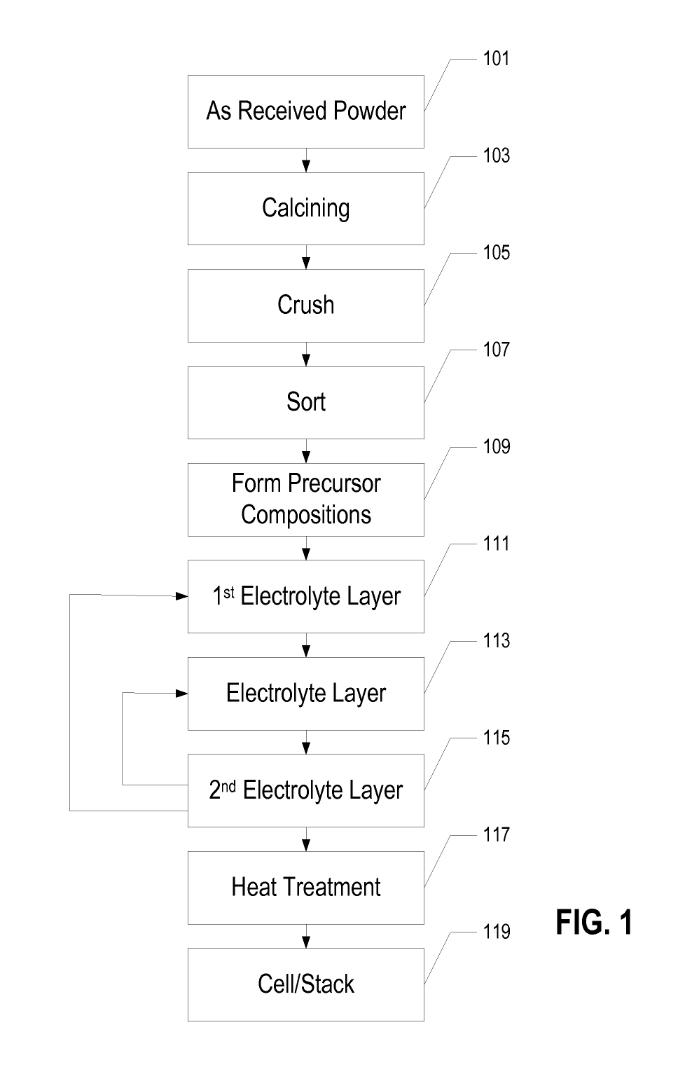

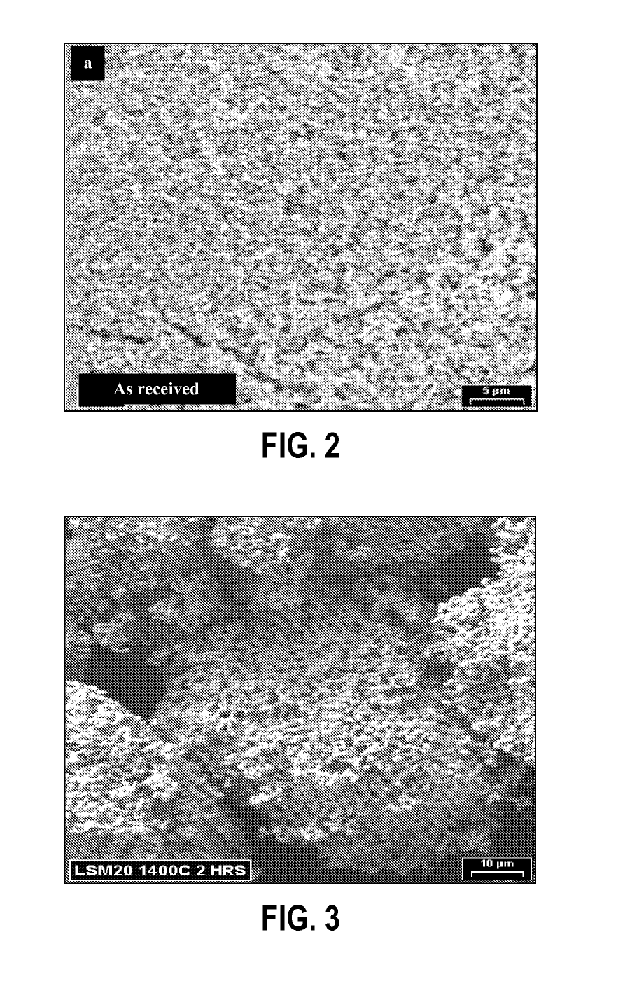

SOFC components, which generally include single SOFC cells composed of a cathode, anode and interposed electrolyte, as well as SOFC cell stacks composed of multiple SOFC cells, may be produced according to a process flow illustrated in FIG. 1. At step 101, as-received electrode powder is obtained. The as-received powder is generally a fine powder and may be sourced commercially. According to one embodiment, the as-received powder in the context of the cathode material may be composed principally of an oxide, such as LSM (lanthanum strontium manganate), and in the context of the anode, the as-received powder may be a two-phase powder composed of an NiO and zirconia, typically stabilized zirconia such as yttria stabilized zirconia. FIG. 2 illustrates a particular as-received powder, commercially available LSM. As shown, the LSM powder has a very fine particle size, with a d₅₀ on the order of 0.5 to 1.0 microns.

Subsequently, the as-received electrode powder is calcined at step 103. Generally, calcination is carried out at an elevated temperature and in an environment to produce agglomeration of the powder. For example, in the context of the LSM powder illustrated in FIG. 2, calcination is carried out in an appropriate crucible that does not react with the powder, such as in an alumina crucible. Calcination may be carried out in air. In one particular embodiment, calcination is carried out by heating the electrode powder at a heating rate, such as within a range of about 1 to 100° C./min., such as 5 to 20° C./min. Thereafter, the powder is held at a suitable calcination temperature, generally within a range of about 900° C. to 1700° C. Oftentimes, the calcination temperature is not less than about 1,000° C., such as not less that about 1,100° C. Typically, the calcination temperature is less than about 1,600° C., such as 1,500° C. Generally, the powder is held at a time period sufficient to cause agglomeration, such as 0.5 to 10 hours, most typically 0.5 to 5 hours, such as 1 to 4 hours. The effect of sintering time and temperature on particle size for LSM powder is reported below in Table 1.

TABLE 1
Particle size a function of calcination conditions for LSM powder.

| Sample Number | Temperature (° C.) | Time (hrs) | D₅₀ (μm) |
|---|---|---|---|
| 1 | As received | 0 | 0.87 |
| 2 | 1000 | 2 | 2.16 |
| 3 | 1000 | 10 | 2.04 |
| 4 | 1200 | 2 | 3.14 |
| 5 | 1200 | 8 | 2.98 |
| 6 | 1400 | 2 | 3.66* |

Noteworthy, sample number 6, in which the LSM powder was calcined at 1,400° C. for two hours, showed bimodal peaks at 2.98 microns and 26.1 microns. The larger peak showing notable agglomeration of the powder.

FIG. 3 illustrates an SEM micrograph of a particular calcined LSM product under the conditions of 1,400° C. in air for two hours. As illustrated, the LSM material was found to have a high degree of agglomeration with porous agglomerates having an average agglomerate size (diameter) not less than about 30 microns. Further, heat treatment at extended time periods and temperatures may be carried out to produce even additional agglomeration.

Typically, the calcination process forms an agglomerated cake of material. The cake of material is not particularly useful for further processing, and accordingly, the cake is generally crushed at step 105 to form individual agglomerates that are composed of grains strongly bonded together through necking and intragranular grain growth between the powder particles of the as-received powder. Following crushing, the agglomerated powder is sorted at step 107. Generally, sorting is carried out by feeding the material through appropriate mesh screens to provide agglomerated particles within a well defined agglomerate size range. For clarification, the agglomerates generally are composed of primary particles associate with grains (having a primary average particle size) in the form of a porous agglomerate mass which itself has a larger particle size, referred to herein as a secondary particle size. According to embodiments herein, the average primary particle size may be within a range of about 0.1 to 10.0 microns, for example. The primary particle size is generally a function of heat treatment conditions during the calcination step. The secondary particle size is generally associated with not only the heat treatment conditions, but also the degree of crushing and the sorting carried out post-calcination. Accordingly, the secondary particle size associated with the agglomerate may be chosen for use in particular areas of the SOFC cell, which will be commented in more detail below. Generally, the average secondary particle size is greater than 4 microns, such as within a range of about 5 to 300 microns. Particular applications within the SOFC cell utilize a fine agglomerate size range, such as about 5 to 100 microns. In other applications, the agglomerates may be coarser, such as greater than 50 microns, typically within a range of about 50 to 300 microns. In these respects, generally the sorting process, such as utilizing sieves, ensures that the sorted agglomerated powders are formed mainly of agglomerates within a predefined agglomerated size range. Generally, the sorted agglomerated powder is composed of at least 75 wt. % agglomerates, such as at least about 85 wt. %, 90 wt. %, or even greater than 95 wt. % agglomerates. In certain embodiments, it is desired that the powders be formed almost entirely of agglomerates, although it is understood that the sorting process may not ensure 100% agglomerated powder.

Processing to form an SOFC component generally continues with step 109 with the formation of precursor compositions for each of the constituents (i.e. electrodes and/or electrolytes) within the SOFC cell or SOFC stack, utilizing agglomerated powder in connection with at least one of the electrodes (i.e., cathode or anode) as described above. The compositions may be formed through any one of a variety of known ceramic processing techniques, such as through formation of a slurry, followed by screen printing, tape casting, or the like. As such, formation of the constituent parts is often completed such that layers are formed. The compositions may be formed into at least one green or precursor cell by layering a first electrode layer at step 111, an electrolyte layer at step 113, and a second electrode layer at step 115. A single cell may be manufactured through a single pass of layer formation or alternatively, the layers may be repeated so as to form a vertical stack of cells. Optionally, not shown, additional layers or features may be integrated in the iterative layering process, such as use of interconnects between adjacent cells so as to form a series connected stack. Alternatively, the cells may be manufactured with respect to each other so as to have shared cathodes and shared anodes, such as a structure as detailed in co-pending application Ser. No. 10/864,285 (Attorney Docket No. 1035-FC4290-US).

According to one embodiment, cells are green-formed by die-pressing successive layers of materials. In one example, the electrodes (cathode and anode) each have two distinct regions, bulk layer portions that are generally composed of fairly large particles, and functional layer portions that form interfacial regions between the bulk layer portions and the electrolyte, the functional layer portions are typically formed of agglomerated powder resulting in finer pores in the functional layer portion relative to the respective bulk regions.

In more detail, one embodiment calls for first layering a bulk layer portion comprising mainly agglomerated cathode powder having agglomerates sized to be within a range of about 50 to 250 microns, such as 50 to 150 microns. Thereafter, a cathode interlayer forming the cathode functional layer portion in the final device is deposited by utilizing a finer agglomerated cathode powder, having a secondary agglomerate particle size within a range of about 20 to 100 microns, such as within a range of about 20 to 50 microns. Alternatively, the interlayer forming the cathode functional layer may be formed of a largely unagglomerated powder, having a notably finer particle size. For example, average particle size can lie within a range of about 0.1 μm to about 10 μm. Typically, the average particle size of the relatively fine material is not greater than about 5 μm. A powder having an average particle size within a range of about 0.5 μm to about 5 μm can be particularly suitable.

Thereafter, an electrolyte layer in the form of an as-received tape-cast green layer is deposited over the cathode materials. The tape-cast electrolyte layer may be formed of zirconia, such as stabilized zirconia, preferably stabilized with yttria. The thickness of the green tape-cast layer may be within a range of about 10 to 200 microns, such as 20 to 150 microns, or even 30 to 100 microns.

In a similar manner to the cathode formation, anode formation may be carried out by depositing an interlayer forming an anode functional layer portion. The interlayer is generally formed of a relatively fine agglomerated powder, having an agglomerate size not greater than about 100 microns, such as not greater than about 75 microns, and in certain embodiments, not greater than about 45 microns. Similarly to the interlayer forming the cathode functional layer, the interlayer forming the anode functional layer may alternatively be formed of a largely unagglomerated powder, having a notably finer particle size. For example, average particle size can lie within a range of about 0.1 μm to about 10 μm. Typically, the average particle size of the relatively fine material is not greater than about 5 μm. A powder having an average particle size within a range of about 0.5 μm to about 5 μm can be particularly suitable.

The anode bulk layer portion is then generally formed of a coarser material, such as agglomerated powder having agglomerates not greater than about 250 microns, such as not greater than about 200 microns. In one particular embodiment, the agglomerates of the anode bulk layer portion were sized to be less than about 150 microns. A particular embodiment is summarized below in Table 2.

TABLE 2

| Component | Material | Material Processing |
|---|---|---|
| Cathode Bulk | LSM | calcined 1400° C./2 h; crushed |
| | | and sized to 75-106 μm |
| Cathode Interlayer | LSM | calcined 1400° C./2 h; crushed |
| | | and sized to 25-45 μm |
| Electrolyte | YSZ | as-received tape-cast |
| Anode Interlayer | NiO/YSZ | calcined 1400° C./2 h; crushed |
| | | and sized to -45 μm |
| Anode Bulk | NiO/YSZ | calcined 1400° C./2 h; |
| | | crushed to -150 μm |

Following formation of a single cell or multiple cells in the form of a cell stack, the SOFC component precursor is then heat treated at step 117 to densify and form an integrated structure. Generally, heat-treating is carried out at an elevated temperature so as to cause consolidation and integration of the various layers, generally referred herein as sintering. As used herein, sintering generally denotes heat treatment operations such as pressureless sintering, uniaxial hot pressing or isostatic pressing (HIPing). According to a particular embodiment herein, the cell or stack precursor is sintered by uniaxial hot-pressing. In one embodiment, single cells and multiple cell stacks were hot pressed at a heating rate of 1° C./min. to 100° C./min., peak temperature within a range of about 1,000° C. to 1,700° C., typically 1,100° C. to 1,600° C., more typically, 1,200° C. to 1,500° C. Pressing may be carried out on the order of 10 min. to 2 hours, such as 15 min. to 1 hour. Particular embodiments were hot pressed for 15 to 45 min. The peak pressure utilized during hot pressing may vary, such as within a range of about 0.5 to 10.0 MPa, such as 1 to 5 MPa. Following cool down, a final cell or stack is provided at step 119.

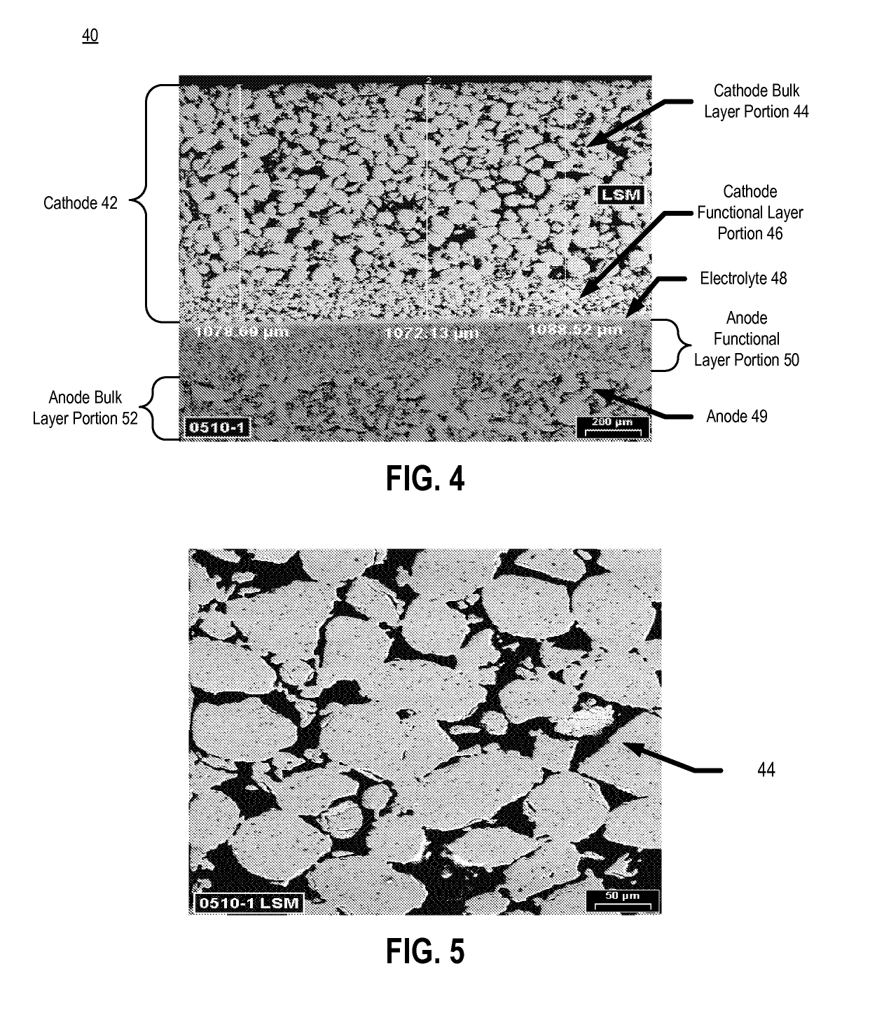

Turning to FIG. 4, a completed solid oxide fuel cell of a fuel cell stack is illustrated post-sintering. The fuel cell 40 is composed of a cathode 42, an electrolyte 48, and an anode 49. Both the cathode and anode have functional layer portions and bulk layer portions. More particularly, cathode 42 includes cathode bulk layer portion 44 and cathode functional layer portion 46. Similarly, anode 49 includes anode bulk layer portion 52 and anode functional layer portion 50. As is clearly shown, the microstructures of the bulk and functional layer portions of the electrodes are contrasting. For example, cathode bulk layer portion 44 is composed of comparatively large grains having associated large pores, the pores forming an interconnected network of porosity. In contrast, the cathode functional layer portion 46 is comparatively fine-grained, with an interconnected network of pores that has a finer geometry. Similarly, the anode bulk layer portion 52 is formed of a large-grained structure with an interconnected network of pores, while the anode functional layer portion 50 has comparatively fine grains with a finer-scale interconnected network of pores. The electrolyte 48 is a comparatively dense material. Although as a natural consequence of processing, some residual porosity may remain in electrolyte 48. However, any such residual porosity is typically closed porosity and not an interconnected network.

Typically, the bulk layer portions of the electrodes have open porosity that is not less than about 15 vol. %, such as not less than about 25 vol. % of the total volume of the respective bulk layer portion. Oftentimes the functional layer portions of the electrodes have comparatively less porosity than the respective bulk layer portions. However, the functional layer portions generally have a porosity not less than about 10 vol. %, such as not less than about 15 vol. % of the total volume of the respective functional layer portion.

Generally, the functional layer portions of the electrodes are comparatively thin relative to the bulk layer portions, and form an interfacial layer directly overlying and in contact with the electrolyte layer sandwiched therebetween. Generally, the functional layer portions have a thickness not less than about 10 microns and in other embodiments with a thickness of not less than about 20 microns, while the bulk layer portions have a thickness not less than about 500 microns. According to one embodiment, the microstructure of at least the cathode has a generally coarse microstructure. Quantitatively, in this embodiment, the cathode has an average grain size not less than about 10 microns, such as not less than about 15 microns. In particular reference to the functional layer portion of the cathode, the average grain size of this region is generally not greater than about 150 microns, such as not greater than about 100 microns, 75 microns, or even not greater than about 50 microns. In connection with description above of using comparatively fine, largely unagglomerated powder for the functional layers of the electrodes, the average grain size of the functional layers can be within a range of about 0.1 μm to about 10 μm, typically not greater than about 5 μm. In this embodiment, grain sizes within a range of about 0.5 μm to about 5 μm can be particularly suitable. The bulk layer portion of the cathode is comparatively coarser than the functional layer portion, generally having an average grain size not less than about 50 microns. As utilized herein, average grain size is determined by averaging measured grains at various portions of the electrode by scanning electrode microscopy (SEM).

Turning more particularly to FIGS. 5 and 6, microstructure of working embodiments of the cathode and anode bulk layer portions 44 and 52 are illustrated. As shown, the average grain size of these bulk layer portions are typically within a range of about 30 to 100 microns for the examples shown.

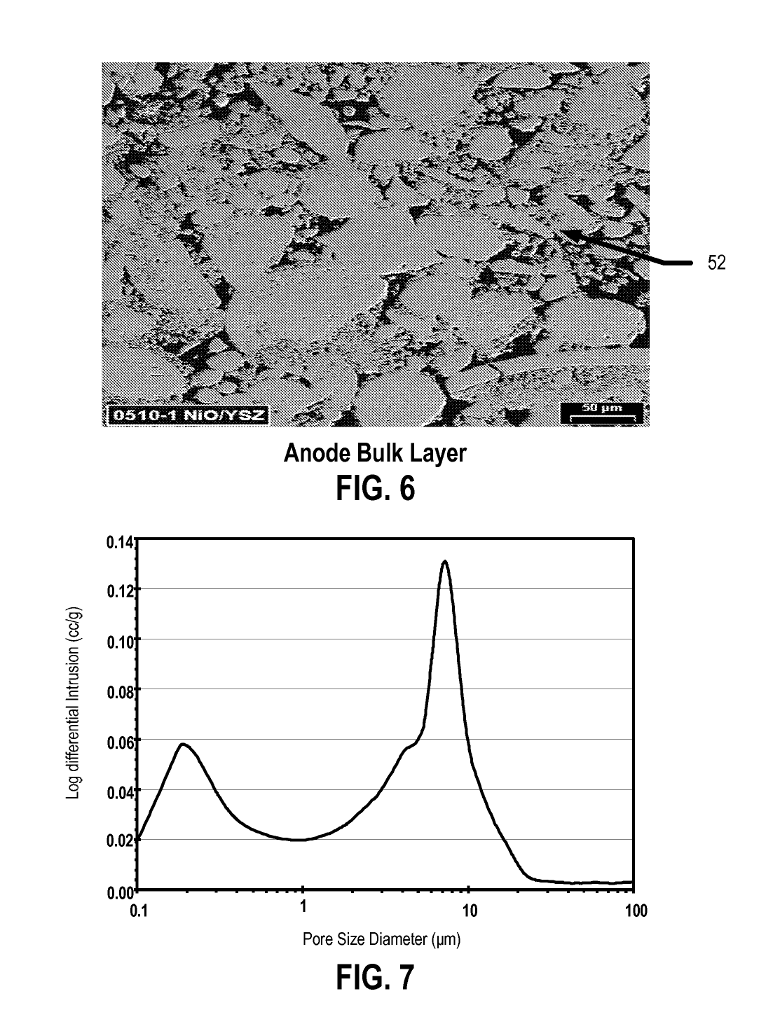

Turning to FIG. 7, a selected portion of a fuel cell, notably including the electrolyte layer 48, cathode functional layer 46, and anode functional layer 50 is illustrated. A comparison of the cathode functional layer 46 with the cathode bulk layer portion shown in FIG. 5 shows a similar microstructure, but with grains on a finer scale, with average grain sizes on the order of 10 to 40 microns.

According to a particular feature of one embodiment, during processing to form the SOFC component, sintering is carried such that at least one of the electrodes formed from an agglomerated raw material undergoes modest shrinkage during sintering and the sintered layer has residual porosity, generally formed of interconnected pores. To quantify, typically the change in density from the green electrode comprised of agglomerated powder to the final electrode post-sintering is defined by ρₛ- ρ_{g} not greater than about 0.3, such as not greater than 0.2, where ρₛ denotes relative sintered density and ρ_{g} denotes relative green density. Use of the terminology ‘relative’ density is well understood in the art and denotes the fraction portion of a 100% dense material, having a density of 1.0. Typical relative green density values ρ_{g} are within a range of 0.4 to 0.5, and typical relative sintered density values ρₛ are within a range of 0.6-0.7. According to one embodiment, such modest shrinkage rates are achievable through utilization of agglomerated powder that is formed through the calcination process described above, thereby limiting the shrinkage during sintering of the SOFC component comprised of a cell or multiple cells. Of note, the residual porosity in the sintered layer may be formed without use of or reliance upon fugitive pore formers. A fugitive pore former is defined herein as a material that is distributed throughout the matrix of the green layer, which is removed during processing. Removal may be achieved through volatilization, for example. According to one aspect, such fugitive pore formers are not relied upon, residual porosity being a result of modest densification and retention of porosity during sintering, particularly retention of notable intragranular porosity from the green state. The following Table 3 summarizes green and sintered densities of bulk cathodes and bulk anodes processed in accordance with Steps 101-109 and 117 of FIG. 1 and utilizing the materials and processing conditions provided in Table 2.

TABLE 3

| | | Sintering | | Relative | | |
|---|---|---|---|---|---|---|
| | | Temp | Time | Density | | |
| Example | Electrode | (° C.) | (min) | g | s | s⁻ g |
| 1 | Cathode | 1550 | 0 | 0.690 | 0.747 | 0.057 |
| 2 | Cathode | 1550 | 0 | 0.717 | 0.761 | 0.044 |
| 3 | Cathode | 1550 | 0 | 0.738 | 0.735 | −0.003 |
| 4 | Cathode | 1380 | 30 | 0.786 | 0.783 | −0.003 |
| 5 | Anode | 1380 | 30 | 0.675 | 0.681 | 0.006 |

According to yet another aspect of an embodiment of the present invention, through use of an agglomerated raw material for formation of at least one of the electrodes, the resulting electrode has a bimodal pore size distribution within at least one of the respective functional layer portion and/or the bulk layer portion.

Referring back to FIG. 6, it can be seen that relatively fine intragranular pores are provided within the grains of the anode bulk layer portion 52, with much larger pores defined between grains of the anode bulk layer portion 52, described herein as intergranular pores. Generally, the spread in average pore size between the fine, generally intragranular pores, and the coarse, generally intergranular pores, is fairly large. Quantitatively, the fine pores have an average pore size P_{f}, and the coarse pores have an average pore size P_{c}, wherein P_{c}/P_{f} is generally not less than about 2.0, such as not less than about 5.0, such as not less than about 5.0 or even not less than about 10.0, representing at least an order of magnitude difference in average pore size between the fine pores and the coarse pores.

Indeed, the bimodal pore size distribution of the bulk anode component is quantified, depicted in FIG. 7. FIG. 7 shows pore distribution by mercury porisometry of an example processed in accordance with steps 101 to 109 and 117 in FIG. 1, using the process conditions and materials shown in Table 2. As depicted, the average pore size P_{c} is 7 μm and the average fine pore size P_{f} is 0.2 μm, yielding a_P_{c}/ P_{f} ratio of 35.

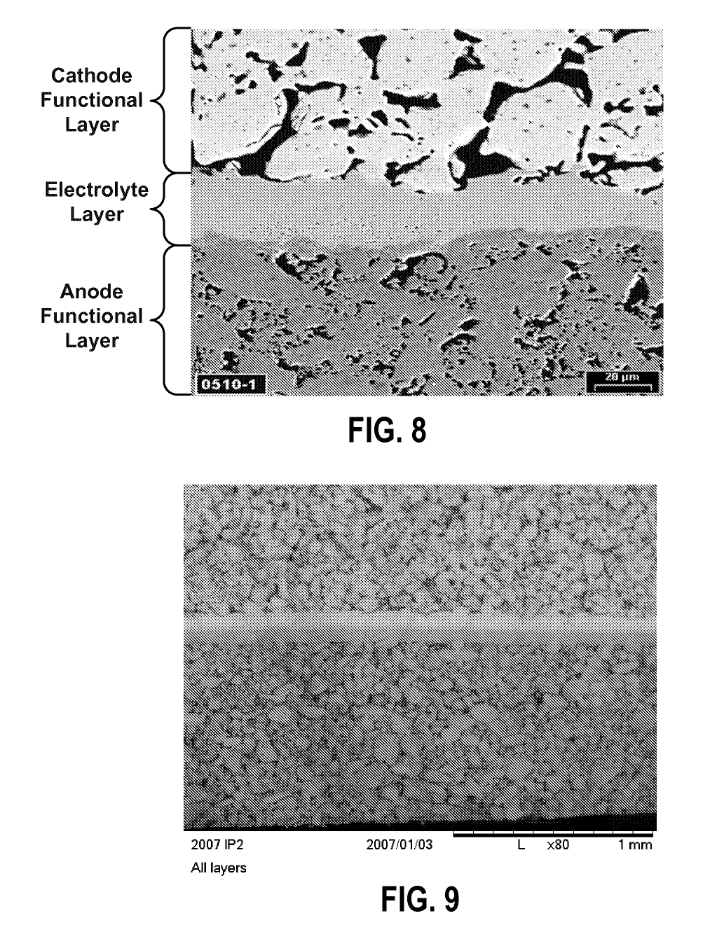

Turning to FIG. 8, it is again seen that not only the cathode bulk layer portion 44, but also the cathode functional layer portion 46, has a bimodal pore size distribution. In the context of the functional layer portion, the fine pores may contribute to improved functionality by increasing the number of “triple point” sites. As used herein, “triple points” represent areas of intersection between the electrolyte layer 46, a pore (gas), and the electrode material (e.g., LSM in the case of the cathode).

According to yet another embodiment, at least one of the electrodes has a bimodal grain size distribution, particularly quantified by G_{c}/G_{f} not less than about 1.5, wherein G_{f} represents the average grain size of fine grains, while G_{c} represents the average grain size of coarse grains. According to certain embodiments, G_{c}/G_{f} is generally not less than about 2.0, such as 2.2, or even not less than about 2.5. Other embodiments may have an even larger spread of grain sizes, such as not less than about 3.0, or even not less than about 5.0. The foregoing coarse/fine ratios are particularly suitable for embodiments that take advantage of agglomerated functional layer materials. Embodiments utilizing comparatively finer functional layer materials, such as unagglomerated powders as described above, may have even a larger spread in grain sizes, such as G_{c}/G_{f} not less than about 10.0, such as not less than about 15.0, not less than about 20.0, or even not less than 25.0. In this respect, generally the bimodal grain size distribution is defined as the average grain size of the bulk layer portion of the electrode relative to the average grain size of the functional layer portion of the same electrode. That is, the bimodal grain size distribution is typically quantified by comparing the average grain sizes of the respective bulk and functional layer portions.

Referring to Table 2, the described structure has a bulk cathode layer having an average grain sizes between 75-106 μm and a cathode functional layer having an average grain size between 25-45 μm, providing a G_{c}/G_{f} ratio within a range of about 1.7 (75 μm/45 μm) to about 4.2 (106 μm/ 25 μm). Similarly, the G_{c}/G_{f} ratio of the anode layer is about 3.3.

As mentioned above, certain embodiments utilize a comparatively fine functional layer, either or both of the cathode and anode functional layers. A particular Example was processed according to the following materials and conditions.

NiO/YSZ anode bulk material was calcined at 1400° C. for 2 hours, crushed and sized to −150 μm. Anode functional material in unagglomerated form was composed of 15 wt % YSZ having a d₅₀ of 0.6 μm, 31 wt % YSZ having a d₅₀ of 0.25 μm, and NiO having a d₅₀ of 2.0 μm.

LSM cathode bulk material was calcined at 1400° C. for 2 hours, crushed and sized to 75-106 μm. A 1:1 ratio of LSM:SDC was calcined at 1050 ° C., sized to −45 μm.

Electrolyte material was composed of 0.75 wt % Al₂O₃-doped YSZ powder.

The anode, cathode and electrolyte materials were tape cast to form layers. The anode functional layer tape, the electrolyte tape and the cathode functional layer tape were laminated at 105° C. under a pressure of 10,000 psi. Thereafter, a green SOFC cell was formed by placing the pressed laminate composed of the anode functional layer tape, the electrolyte tape and the cathode functional layer tape on cathode bulk material in a die, and placing the anode bulk material over the pressed laminate. Densification was then carried out by hot-pressing the thus formed green structure.

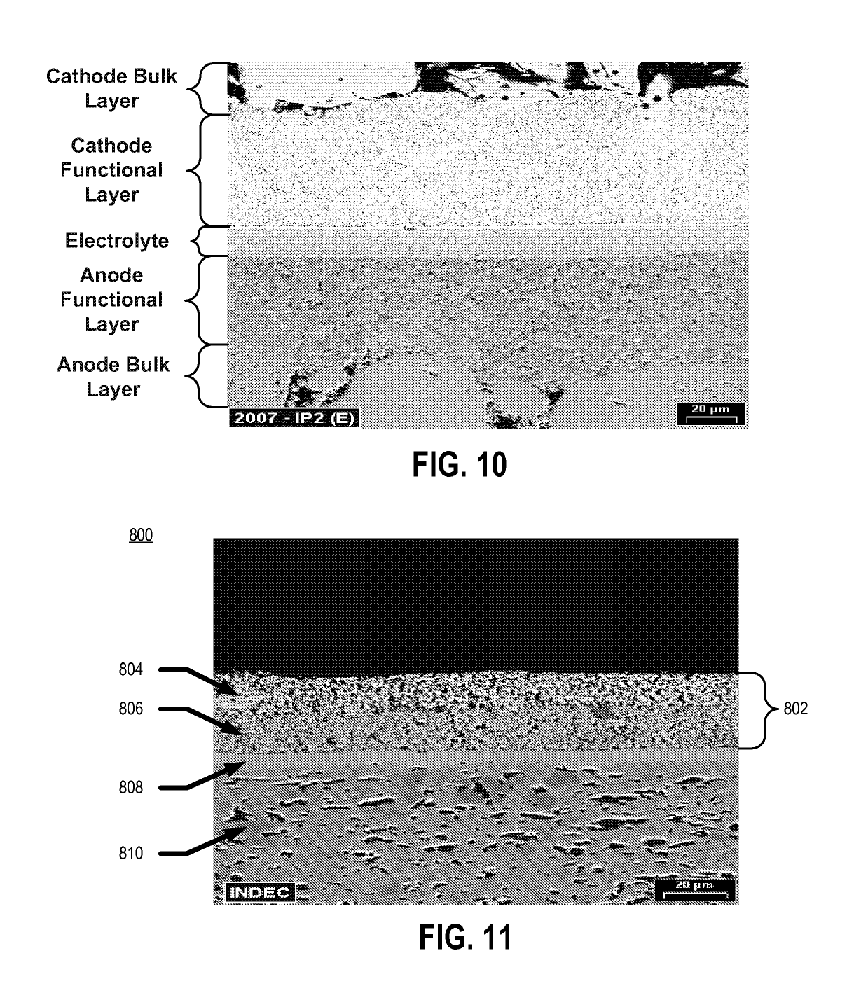

The resulting structure is shown in FIG. 9, which is a fractured and polished section depicting the constituent layers of the SOFC cell. FIG. 10 is an exploded view of FIG.10, clearly showing the quite significant different in grain size between the bulk electrode layers and respective functional layers

For comparative purposes, attention is drawn to FIG. 11 which illustrates a state-of-the art fuel cell 800 having a cathode 802, and electrolyte 808, and an anode 810. As illustrated, the cathode 802 includes a cathode bulk layer portion 804 and a cathode functional layer portion 806. The average grain size of the cathode 802 is generally within the range of about 1 to 4 microns, and the spread in grain sizes between the bulk layer portions and functional layer portions of the cathode is notably modest. It is believed that the prior art structure shown in FIG. 11 has been formed through a subtractive process in which fugitive components in the cathode are volatilized, and a conventional, non-calcined fine-grained (non-agglomerated) raw material is utilized for processing.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An SOFC component, comprising:
a first electrode;
an electrolyte overlying the first electrode; and
a second electrode overlying the electrolyte, the second electrode comprising a bulk layer portion and a functional layer portion, the functional layer portion being an interfacial layer extending between the electrolyte and the bulk layer portion of the second electrode, wherein the bulk layer portion has a bimodal pore size distribution including fine pores and coarse pores that are larger than the fine pores, the fine pores being intragranular pores and the coarse pores being intergranular pores.

2. The SOFC component of claim 1, wherein the functional layer portion has a bimodal pore size distribution.

3. The SOFC component of claim 1, wherein the bulk layer portion has an average grain size larger than the functional layer portion.

4. The SOFC component of claim 1, wherein bulk layer portion has an average grain size not less than 50 microns.

5. The SOFC component of claim 1, wherein the bulk layer portion has a thickness greater than that of the functional layer portion, the functional layer portion has a thickness not less than about 10 microns and the bulk layer portion has a thickness not less than about 500 microns.

6. The SOFC component of claim 1, wherein bulk layer portion comprises fine pores having an average pore size P_{f} and coarse pores having an average pore size P_{c}, wherein P_{c}/P_{f} is not less than about 2.0.

7. The SOFC component of claim 1, wherein the bulk layer portion has a percent porosity of not less than about 15 vol %.

8. The SOFC component of claim 1, wherein the functional layer portion has a percent porosity of not less than about 10 vol %.

9. The SOFC component of claim 1, wherein the first electrode comprises a bulk layer portion and a functional layer portion, the functional layer portion being an interfacial layer extending between the electrolyte and the bulk layer portion of the first electrode, wherein the bulk layer portion of the first electrode has a bimodal pore size distribution.

10. The SOFC component of claim 1, wherein one of the first and second electrodes is a cathode, the cathode comprising a ceramic oxide of lanthanum and manganese.

11. The SOFC component of claim 1, wherein electrolyte comprises zirconia.

12. The SOFC component of claim 1, wherein one of the first and second electrodes is an anode, the anode comprising a cermet.

13. The SOFC component of claim 1, wherein the first and second electrodes and the electrolyte form an SOFC cell, the SOFC component comprising multiple SOFC cells in the form of a stack.

14. A SOFC component, comprising:
a first electrode;
an electrolyte overlying the first electrode; and
a second electrode overlying the electrolyte, wherein the second electrode comprises a bulk layer portion having a bimodal pore size distribution, and wherein bulk layer portion comprises fine pores and coarse pores that are larger than the fine pores, the fine pores being intragranular pores and the coarse pores are intergranular pores.

15. The SOFC component of claim 14, wherein the second electrode is a cathode.

16. The SOFC component of claim 14, wherein the second electrode is an anode.

17. The SOFC component of claim 14, wherein the second electrode comprises a functional layer portion, the functional layer portion being an interfacial layer extending between the electrolyte and the bulk layer portion of the second electrode.

18. A SOFC component, comprising:
a first electrode;
an electrolyte overlying the first electrode; and
a second electrode overlying the electrolyte,
wherein the second electrode comprises a bulk layer portion having a bimodal pore size distribution,
wherein the bulk layer portion comprises fine pores having an average pore size P_{f} and coarse pores having an average pore size P_{c},
wherein the coarse pores are larger than the fine pores,
wherein the ratio P_{c}/P_{f} is not less than about 2.0, and
wherein the fine pores are intragranular pores and the coarse pores are intergranular pores.

19. The SOFC component of claim 18, wherein the second electrode has a relative sintered density ρₛ in the range of 0.65 to 0.783.

20. The SOFC component of claim 18, wherein the bulk layer portion is comprised of agglomerates having a secondary particle size in the range of 5 to 300 microns.
